(19) United States
(12) Patent Application Publication
(10) Pub. No.: US 2013/0248523 A1
(43) Pub. Date: Sep. 26, 2013

(54) MICROWAVE OVEN

(71) Applicant: Tae Wha Kim, Buncheon-si (KR)

(72) Inventor: Tae Wha Kim, Buncheon-si (KR)

(73) Assignee: Dongbu Daewoo Electronics, Seoul (KR)

(21) Appl. No.: 13/988,540

(22) PCT Filed: Nov. 24, 2011
(86) PCT No.: PCT/KR11/09021

§ 371 Date: May 21, 2013

(30) Foreign Application Priority Data
Nov. 25, 2010 (KR) 10-2010-0118385

(51) Int. Cl. H05B 6/64

(52) U.S. Cl. CPC H05B 6/6402
USPC 219/757

(57) ABSTRACT

A microwave oven includes: a cabinet forming the exterior; a base plate coupled to the cabinet and forming a bottom surface; a rear plate coupled to the cabinet and forming a rear surface; a cavity installed on the base plate to form a space at a rear side of the base plate; first and high-voltage transformers positioned in the space, and installed in one side and the center of the base plate, respectively; a first magnetron positioned in the space and disposed in the opposite side of the first high-voltage transformer; a second magnetron positioned in the space and disposed over the first magnetron; a fan assembly positioned in the space and disposed over the first transformer; a fan housing covering the fan assembly; and an air guide tube connected to the fan housing, and guiding an air flow to the first and second magnetrons.

### FIELD OF TECHNOLOGY

The present invention relates to a microwave oven, and more particularly, to a microwave oven in which electronic parts are disposed in a space formed at a rear side of a cavity so as to be smoothly cooled down by one cooling fan.

### BACKGROUND

In general, a microwave oven is a device for cooking food through intermolecular frictional heat generated by disturbing the molecular arrangement of the food using a high frequency of about 2, 450 MHz as a heating source.

Such a microwave oven may be mainly divided into a type having a single magnetron and a type having a plurality of magnetrons.

The microwave oven having a single magnetron may be used as a microwave oven for home use which is used at a low frequency, and the large-sized microwave oven having a plurality of magnetrons may be used as a microwave oven for business use which is used at a high frequency.

The above-described configuration is a related art for helping an understanding of the present invention, and does not mean a related art which is widely known in the technical field to which the present invention pertains.

### SUMMARY

### Technical Problem

Since the conventional large-sized microwave oven includes a plurality of electronic parts which are spread here and there, the microwave oven has a complex structure for cooling the electronic parts. Furthermore, since the conventional microwave oven includes a plurality of cooling fans to obtain sufficient cooling efficiency, the structure becomes complex, and the manufacturing cost increases.

Therefore, there is a demand for a structure capable of solving the problems.

The present invention is conceived to solve such problems of the related art, and an aspect of the invention is to provide a microwave oven in which electronic parts are disposed in a space formed at a rear side of a cavity so as to be smoothly cooled down by one cooling fan.

### Technical Solution

According to an aspect of the invention, a microwave oven includes: a cabinet forming the exterior of the microwave oven; a base plate coupled to the cabinet and forming a bottom surface of the microwave oven; a rear plate coupled to the cabinet and forming a rear surface of the microwave oven; a cavity installed on the base plate so as to be spaced from the rear plate, thereby forming a space at a rear side of the base plate; a first high-voltage transformer positioned in the space, and installed in one side of the base plate; a second high-voltage transformer positioned in the space, and installed in the center of the base plate; a first magnetron positioned in the space and disposed in the opposite side of the first high-voltage transformer; a second magnetron positioned in the space and disposed over the first magnetron; a fan assembly positioned in the space and disposed over the first transformer; a fan housing covering the fan assembly and having an air introduction portion formed to face the first high-voltage transformer; and an air guide tube connected to the fan housing, and guiding an air flow generated by operation of the fan assembly to the first and second magnetrons.

The base plate may include air suction holes formed at a front surface thereof, through which air is introduced.

The external air may be introduced through the air suction holes by the operation of the fan assembly, and then introduced to the fan housing through the air introduction portion while cooling down the first and second high-voltage transformers.

The cavity may include: a side plate formed in a U-shape to form both side surfaces and a rear surface of the cavity and spaced from the rear plate; a top plate coupled to the top of the side plate, and protruded rearward from the side plate so as to be coupled to the rear plate; and a bottom plate coupled to the bottom of the side plate, and protruded rearward from the side plate so as to be coupled to the rear plate.

The top plate may be coupled to the second magnetron, and the bottom plate may be coupled to the first magnetron.

The bottom plate may have a groove portion formed at an edge thereof so as not to interfere with the first and second high-voltage transformers.

The air guide tube may be positioned in the space and has one side connected to the fan housing and the other side divided into two portions, a first divided portion may be bent downward toward the first magnetron, and a second divided portion may be bent upward toward the second magnetron.

The first divided portion may be coupled to the first magnetron between the second high-voltage transformer and the first magnetron, and the second divided portion may be coupled to the second magnetron between the second magnetron and the fan assembly.

The rear plate may have a first discharge hole through which air having cooled down the first magnetron is discharged.

The rear plate may have a second discharge hole through which air having cooled down the second magnetron is discharged.

### Advantageous Effects

According to the embodiment of the invention, since various electronic parts may be cooled down by one fan assembly, the size of the microwave oven may be reduced, and the number of parts may be simplified.

Furthermore, since the plurality of high-voltage transformers and magnetrons may be cooled down by one fan assembly, the cooling structure may be simplified.

Furthermore, the manufacturing cost may be simplified by the reduction in the number of parts and the simplification of the cooling structure.

### BRIEF DESCRIPTION

The above and other aspects, features and advantages of the invention will become apparent from the following detailed description in conjunction with the accompanying drawings, in which:

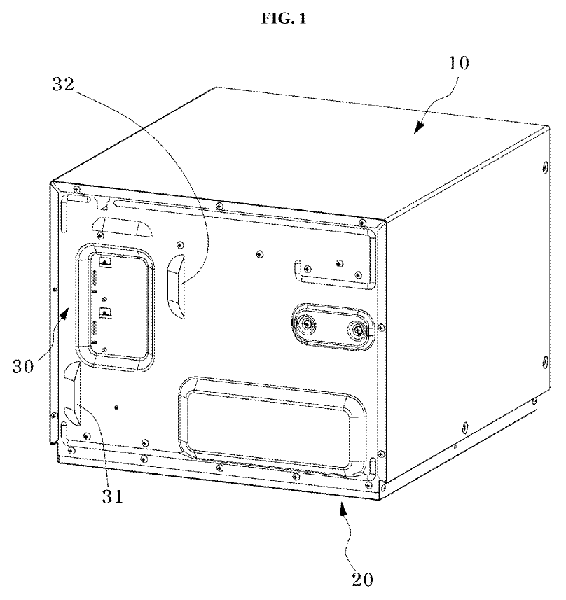

FIG. 1 is a rear perspective view of a microwave oven in accordance with an embodiment of the present invention;

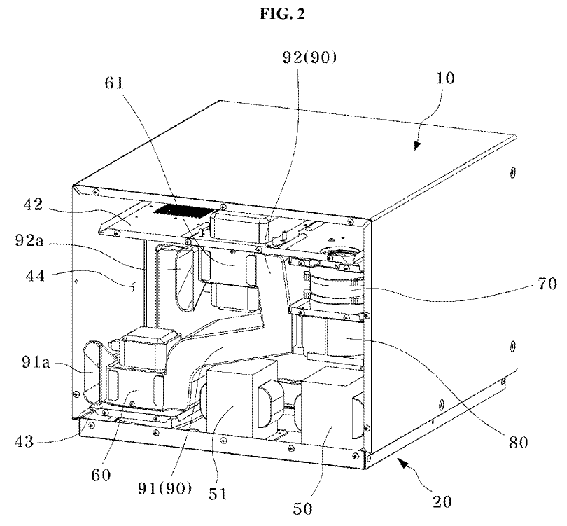

FIG. 2 is a rear perspective view of the microwave oven in accordance with the embodiment of the present invention, illustrating a state in which a rear plate is removed;

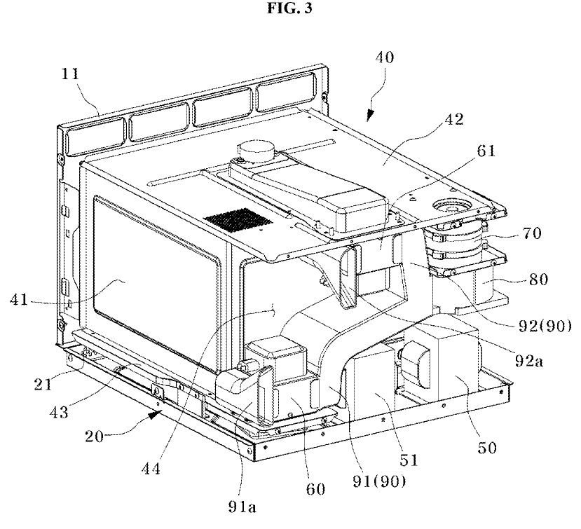

FIG. 3 is a rear perspective view of the microwave oven in accordance with the embodiment of the present invention, illustrating a state in which a cabinet and the rear plate are removed;

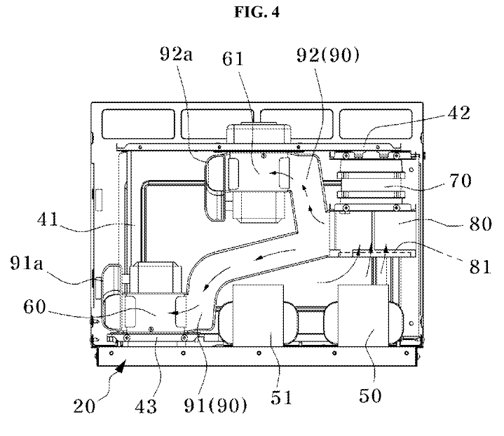

FIG. 4 is a rear view of the microwave oven in accordance with the embodiment of the present invention, illustrating a state in which the cabinet and the rear plate are removed;

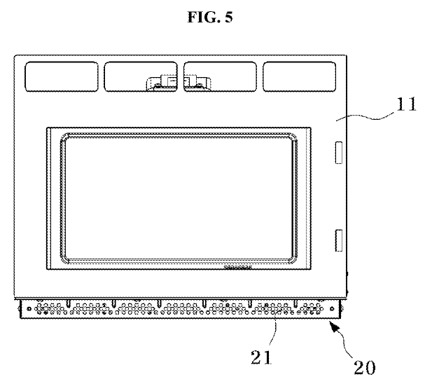

FIG. 5 is a side view of the microwave oven in accordance with the embodiment of the present invention, illustrating a state in which the cabinet is removed;

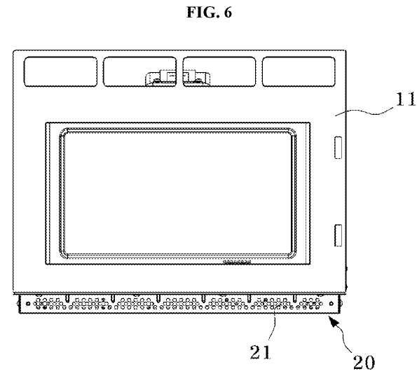

FIG. 6 is a front view of the microwave oven in accordance with the embodiment of the present invention, illustrating a state in which the cabinet is removed;

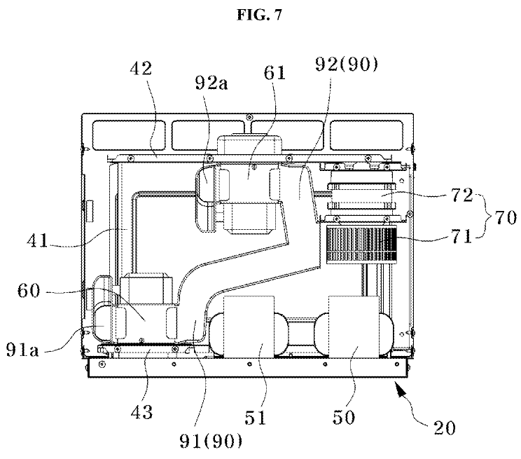

FIG. 7 is a rear view of the microwave oven in accordance with the embodiment of the present invention, illustrating a state in which a fan housing is removed from FIG. 4;

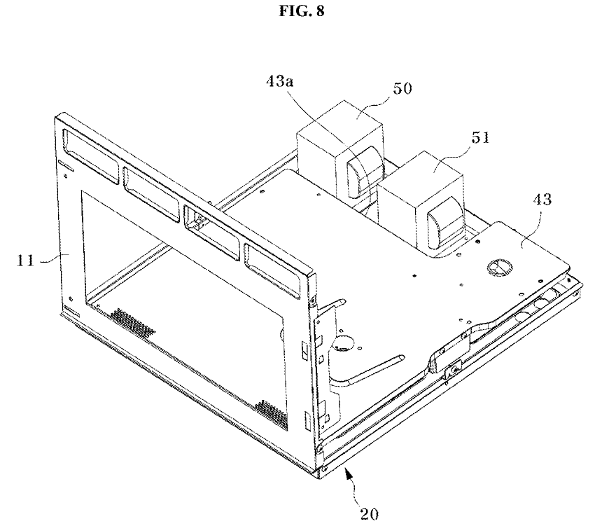

FIG. 8 is a perspective view of a bottom plate of the microwave oven in accordance with the embodiment of the present invention; and

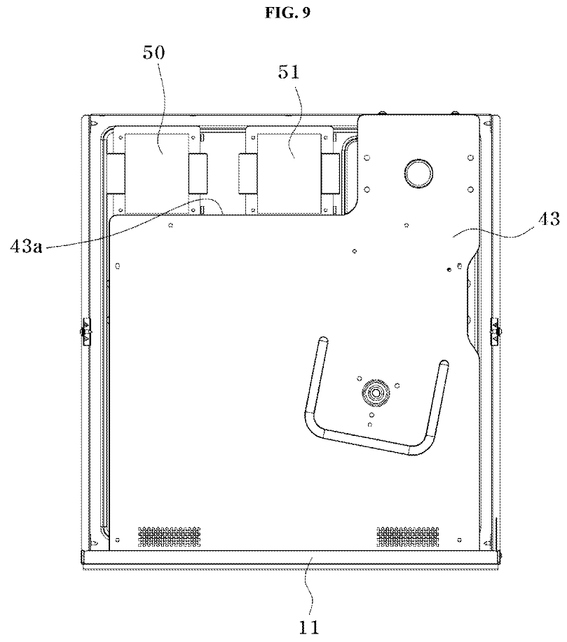

FIG. 9 is a plan view of the bottom plate of the microwave oven in accordance with the embodiment of the present invention.

### DETAILED DESCRIPTION

Embodiments of the invention will hereinafter be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

FIG. 1 is a rear perspective view of a microwave oven in accordance with an embodiment of the present invention. FIG. 2 is a rear perspective view of the microwave oven in accordance with the embodiment of the present invention, illustrating a state in which a rear plate is removed. FIG. 3 is a rear perspective view of the microwave oven in accordance with the embodiment of the present invention, illustrating a state in which a cabinet and the rear plate are removed. FIG. 4 is a rear view of the microwave oven in accordance with the embodiment of the present invention, illustrating a state in which the cabinet and the rear plate are removed. FIG. 5 is a side view of the microwave oven in accordance with the embodiment of the present invention, illustrating a state in which the cabinet is removed. FIG. 6 is a front view of the microwave oven in accordance with the embodiment of the present invention, illustrating a state in which the cabinet is removed. FIG. 7 is a rear view of the microwave oven in accordance with the embodiment of the present invention, illustrating a state in which a fan housing is removed from FIG. 4. FIG. 8 is a perspective view of a bottom plate of the microwave oven in accordance with the embodiment of the present invention. FIG. 9 is a plan view of the bottom plate of the microwave oven in accordance with the embodiment of the present invention.

Referring to FIGS. 1 to 3, the microwave oven in accordance with the embodiment of the present invention includes a cabinet 10, a base plate 20, a rear plate 30, a cavity 40, a first high-voltage transformer 50, a second high-voltage transformer 51, a first magnetron 60, a second magnetron 61, a fan assembly 70, a fan housing 80, and an air guide tube 90.

The cabinet 10 is formed in a plate shape bend in a U-shape and forms both side surfaces and the top surface of the exterior of the microwave oven. The base plate 20 is coupled to the bottom of the cabinet 10, and forms the bottom surface of the exterior of the microwave oven.

The base plate 20 includes a plurality of air suction holes 21 formed on the front surface thereof. The air suction holes 21 are formed from one side to the other side of the base plate 20, and the external air is introduced into the microwave oven through the air suction holes 21.

The rear plate 30 is coupled to the rear end of the cabinet 10, and forms the rear surface of the exterior of the microwave oven. The front plate 11 is coupled to the front end of the cabinet 10, and forms the front surface of the exterior of the microwave oven.

Referring to FIGS. 3 to 6, the cavity 40 forms a cooking room, and is installed on the base plate 20. The cavity 40 includes a side plate 41, a top plate 42, and a bottom plate 43.

The side plate 41 is formed in a plate shape bent in a U-shape, and forms both side surfaces and the rear surface of the cavity 40. The top plate 42 is coupled to an upper end of the side plate 41 so as to form the top surface, and the bottom plate 43 is coupled to a lower end of the side plate 41 so as to form the bottom surface.

The rear surface of the side plate 41 is spaced from the rear plate 30, thereby forming a space 44 therebetween. That is, the space 44 is defined at the rear side (right side in FIG. 5) of the base plate 20 by the rear surface of the side plate 41 and the rear plate 30.

The top plate 42 is protruded rearward from the side plate 41 and coupled to the rear plate 30. The bottom plate 43 is protruded rearward from the side plate 41 and coupled to the rear plate 30.

Therefore, the cavity 40 is reliably fixed and coupled to the rear plate 30 by the top plate 42 and the bottom plate 43, even though the side plate 41 is separated from the rear plate 30.

The first high-voltage transformer 50 is positioned in the space 44, and installed in one side (right side of FIG. 3) of the base plate 20. The second high-voltage transformer 51 is positioned in the space 44, and installed in the center of the base plate 20.

The first and second high-voltage transformers 50 and 51 are arranged in parallel to each other, when seen from the front. Furthermore, the first and second high-voltage transformers 50 and 51 are arranged to overlap each other, when seen from the side.

The first magnetron 60 is positioned in the space 44, and disposed in the opposite side of the first high-voltage transformer 50. That is, the first magnetron 60 is disposed in the other side (left side of FIG. 3) of the base plate 20, and coupled to the top surface of the bottom plate 43.

The second magnetron 61 is positioned in the space 44, and disposed over the first magnetron 60. The second magnetron 61 is coupled to the bottom surface of the top plate 42, and disposed in the center when seen from the front.

Microwaves generated by the first and second magnetrons 60 and 61 are provided to upper and lower spaces of the cavity 40, respectively, through a waveguide (not illustrated).

Referring to FIGS. 8 and 9, the bottom plate 43 has a groove portion 43a formed at an edge thereof so as not to interfere with the pair of high-voltage transformers 50 and 51 installed on the base plate 20. In accordance with the embodiment of the present invention, the bottom plate 43 is formed in an L-shape, and coupled to the rear plate 30 through a portion protruded toward the rear side. Furthermore, the high-voltage transformers 50 and 51 may be easily installed on the base plate 20 through a portion depressed from a corner edge of the bottom plate 43, that is, the groove portion 43a.

Referring to FIGS. 3, 4, and 7, the fan assembly 70 is positioned in the space 44, and disposed over the first high-voltage transformer 50. The fan assembly 70 includes a cooling fan 71 and a fan motor 72 to transmit a driving force to the cooling fan 71. In accordance with the embodiment of the present invention, the fan motor 72 is disposed over the cooling fan 71.

The fan housing 80 covers the fan assembly 70. Specifically, since the fan housing 80 covers only the cooling fan 71, the fan motor 72 is disposed in a space separate from the cooling fan 71 by the fan housing 80. Accordingly, heat generated by the operation of the fan motor 72 is prevented from being contacted with external air introduced to the fan housing 80.

The fan housing 80 has an air introduction portion 81 formed at the bottom thereof. The air introduction portion 81 is formed to face the first high-voltage transformer 50, and serves as an entrance of air introduced to the fan housing 80 while cooling the first and second high-voltage transformers 50 and 51.

The air guide tube 90 is connected to the fan housing 80, guides an air flow generated by the operation of the fan assembly 70 to the first and second magnetrons 60 and 61, and cools down the first and second magnetrons 60 and 61.

The air guide tube 90 is positioned in the space 44, and has one side connected to a side portion of the fan housing 80 and the other side formed to face the first and second magnetrons 60 and 61. The other side of the air guide tube 90 is divided into two portions. Between the two portions, a first divided portion 91 is formed to be bent downward toward the first magnetron 60, and a second divided portion 92 is formed to be bent upward toward the second magnetron 61.

The first divided portion 91 is coupled to the first magnetron 60 between the second high-voltage transformer 51 and the first magnetron 60 so as not to interfere with the second high-voltage transformer 51. That is, based on FIG. 4, the first divided portion 91 is formed to be bent downward past the second high-voltage transformer 51 and coupled to a side portion of the first magnetron 60.

The second divided portion 92 is coupled to a side portion of the second magnetron 61 between the fan motor 72 and the second magnetron 61 such that the length of the second divided portion 92 is minimized.

The air introduced from outside by the operation of the fan assembly 80 is introduced to the fan housing 80 through the air introduction portions 81. Then, the air is guided by the first divided portion 91 and cools down the first magnetron 60. The air heated while cooling down the first magnetron 60 is guided by a first connection tube 91a and discharged to the outside through a first discharge hole 31 formed in the rear plate 30.

That is, when the air having cooled down the first magnetron 60 remains in the microwave oven, the internal temperature of the microwave oven is increased. Therefore, in order to prevent the increase of the internal temperature, the rear plate 30 has the first discharge hole 31 to discharge the air to the outside. Therefore, the first discharge hole 31 is formed at a place corresponding to the installation position of the first magnetron 60.

Furthermore, the air introduced by the operation of the fan assembly 80 is guided by the second divided portion 92 so as to cool down the second magnetron 61, and then guided by a second connection tube 92a so as to be discharged to the outside through a second discharge hole 32 formed in the rear plate 30.

That is, when the air having cooled down the second magnetron 61 remains in the microwave oven, the internal temperature of the microwave oven is increased. Therefore, in order to prevent the internal temperature of the microwave oven, the rear plate 30 has the second discharge hole 32 formed to discharge the air to the outside. Therefore, the second discharge hole 32 is formed at a place corresponding to the installation position of the second magnetron 61.

Hereinafter, referring to the accompanying drawings, the air flow process in the microwave oven in accordance with the embodiment of the present invention will be described.

When the operation of the microwave oven is started, the fan motor 72 is driven to rotate the cooling fan 71. The rotations of the cooling fan 71 generate an air suction force, and the external air is introduced into the microwave oven through the air suction holes 21 formed at the front surface of the base plate 20 by the air suction force.

The air is moved to the fan housing 80, in which the air suction force is generated, through the space formed by the base plate 20 and the bottom plate 43 of the cavity 40.

The first and second high-voltage transformers 50 and 51 are disposed in the space 44 at the rear side of the base plate 20, and the fan housing 80 is disposed over the first high-voltage transformer 50. Accordingly, the air is introduced to the fan housing 80 through the first and second high-voltage transformers 50 and 51. Therefore, the first and second high-voltage transformers 50 and 51 placed on the flow path of the air are automatically cooled by the air.

Since the groove portion 43a is formed in the bottom plate 43 guiding the air flow and the first and second high-voltage transformers 50 and 51 are disposed at the position corresponding to the groove portion 43a, the cooling efficiency is improved more than when the first and second high-voltage transformers 50 and 51 are disposed at different positions.

The air which is introduced to the fan housing 80 through the air introduction portion 81 while cooling down the first and second high-voltage transformers 50 and 51 is guided by the first and second divided portions 91 and 92 communicating with the fan housing 80, thereby cooling down the first and second magnetrons 60 and 61.

The air having cooled down the first magnetron 60 is guided by the first connection tube 91a and discharged to the outside through the first discharge hole 31, and the air having cooled down the second magnetron 61 is guided by the second connection tube 92a and discharged to the outside through the second discharge hole 32.

Although some embodiments have been provided to illustrate the invention in conjunction with the drawings, it will be apparent to those skilled in the art that the embodiments are given by way of illustration only, and that various modifications and equivalent embodiments can be made without departing from the spirit and scope of the invention. The scope of the invention should be limited only by the accompanying claims.

1. A microwave oven comprising:
a cabinet forming the exterior of the microwave oven;
a base plate coupled to the cabinet and forming a bottom surface of the microwave oven;
a rear plate coupled to the cabinet and forming a rear surface of the microwave oven;
a cavity installed on the base plate so as to be spaced from the rear plate, thereby forming a space at a rear side of the base plate;
a first high-voltage transformer positioned in the space, and installed in one side of the base plate;
a second high-voltage transformer positioned in the space, and installed in the center of the base plate;
a first magnetron positioned in the space and disposed in the opposite side of the first high-voltage transformer;
a second magnetron positioned in the space and disposed over the first magnetron;
a fan assembly positioned in the space and disposed over the first transformer;
a fan housing covering the fan assembly and having an air introduction portion formed to face the first high-voltage transformer; and
an air guide tube connected to the fan housing, and guiding an air flow generated by operation of the fan assembly to the first and second magnetrons.

2. The microwave oven of claim 1, wherein the base plate comprises air suction holes formed at a front surface thereof, through which air is introduced.

3. The microwave oven of claim 2, wherein the external air is introduced through the air suction holes by the operation of the fan assembly, and then introduced to the fan housing through the air introduction portion while cooling down the first and second high-voltage transformers.

4. The microwave oven of claim 1, wherein the cavity comprises:
a side plate formed in a U-shape to form both side surfaces and a rear surface of the cavity and spaced from the rear plate;
a top plate coupled to the top of the side plate, and protruded rearward from the side plate so as to be coupled to the rear plate; and
a bottom plate coupled to the bottom of the side plate, and protruded rearward from the side plate so as to be coupled to the rear plate.

5. The microwave oven of claim 4, wherein the top plate is coupled to the second magnetron, and the bottom plate is coupled to the first magnetron.

6. The microwave oven of claim 4, wherein the bottom plate has a groove portion formed at an edge thereof so as not to interfere with the first and second high-voltage transformers.

7. The microwave oven of claim 1, wherein the air guide tube is positioned in the space and has one side connected to the fan housing and the other side divided into two portions, a first divided portion is bent downward toward the first magnetron, and a second divided portion is bent upward toward the second magnetron.

8. The microwave oven of claim 7, wherein the first divided portion is coupled to the first magnetron between the second high-voltage transformer and the first magnetron, and
the second divided portion is coupled to the second magnetron between the second magnetron and the fan assembly.

9. The microwave oven of claim 7, wherein the rear plate has a first discharge hole through which air having cooled down the first magnetron is discharged.

10. The microwave oven of claim 7, wherein the rear plate has a second discharge hole through which air having cooled down the second magnetron is discharged.
